(19) United States
(12) Patent Application Publication
(10) Pub. No.: US 2015/0130983 A1
(43) Pub. Date: May 14, 2015

(54) POLARIZER, OPTICAL APPARATUS, LIGHT SOURCE APPARATUS, AND IMAGE PICKUP APPARATUS

(71) Applicant: CANON KABUSHIKI KAISHA, Tokyo (JP)

(72) Inventor: Yutaka Yamaguchi, Utsunomiya-shi (JP)

(21) Appl. No.: 14/534,577

(22) Filed: Nov. 6, 2014

(30) Foreign Application Priority Data
Nov. 13, 2013 (JP) 2013-234504

(51) Int. Cl. G02B 5/30; H04N 5/232

(52) U.S. Cl. CPC G02B 5/3058; G02B 5/3041; H04N 5/23293
USPC 348/333.09; 359/487.03

(57) ABSTRACT

A polarizer includes a first medium disposed at an emission side, a second medium disposed at an incident side, and a plurality of laminated structures provided at a predetermined grating period in a grating period direction, the laminated structure includes, in order from the first medium to the second medium, a first dielectric layer, a metallic layer, and a second dielectric layer between the first medium and the second medium, the polarizer is configured to reflect polarized light oscillating in a direction orthogonal to the grating period direction in a particular wavelength band and to transmit light other than the polarized light, and predetermined expressions are satisfied.

### BACKGROUND OF THE INVENTION

1. Field of the Invention

The present invention relates to a polarizer having a narrow wavelength band polarization characteristic.

2. Description of the Related Art

A polarizer transmits, of incident polarized light, linearly polarized light oscillating in a specific direction and reflects (or absorbs) polarized light oscillating in a direction orthogonal to the specific direction. Known polarizers that operate in a visible light wavelength include a dichroic polarizer formed typically through film orientation and a wire grid polarizer including a fine metallic grating smaller than the wavelength. These polarizers desirably have, in general, uniform optical properties over the entire range of the visible light wavelength. However, an optical element in a liquid crystal projector and an optical apparatus including a light source that emits light such as laser light in a narrow wavelength band require, in some cases, a polarizer that functions only in red, green, blue bands, or in a predetermined narrow wavelength band. The use of a narrow band polarizer can reduce a loss in synthesizing, for example, light from a narrow band light source and wide band light such as white light.

Japanese Patent Laid-open No. 2006-154382 discloses a polarizer having a peak in a specific band due to a controlled thickness of a metallic grating in a wire grid polarizer. Japanese Patent Laid-open No. 2006-145884 discloses a polarizing beam splitter laminated with a film having a refractive index anisotropy so as to serve as a transmissive film having a uniform refractive index for specific linearly polarized light and serve as a reflective film having a refractive index difference for polarized light orthogonal to the specific linearly polarized light.

However, the wire grid polarizer disclosed in Japanese Patent Laid-open No. 2006-154382 generally includes a metallic grating having a finite thickness, and thus have a light quantity loss due to absorption. The configuration disclosed in Japanese Patent Laid-open No. 2006-145884 needs to have a plurality of anisotropic thin films laminated, and thus potentially has a light quantity loss due to scattering and absorption. Japanese Patent Laid-open No. 2006-154382 and Japanese Patent Laid-open No. 2006-145884 each discloses a polarizer that operates on light in the red, green, and blue bands. However, the bandwidth of the polarizer is large for a light source that emits light such as laser light in a narrow band, which degrades efficiency in, for example, an optical path synthesis.

### SUMMARY OF THE INVENTION

The present invention provides a polarizer, an optical apparatus, alight source apparatus, and an image pickup apparatus that have a narrow wavelength band polarization characteristic.

A polarizer as one aspect of the present invention includes a first medium disposed at an emission side, a second medium disposed at an incident side, and a plurality of laminated structures provided at a predetermined grating period in a grating period direction, the laminated structure includes, in order from the first medium to the second medium, a first dielectric layer, a metallic layer, and a second dielectric layer between the first medium and the second medium, the polarizer is configured to reflect polarized light oscillating in a direction orthogonal to the grating period direction in a specific wavelength band and to transmit light other than the polarized light, and predetermined expressions are satisfied.

An optical apparatus as another aspect of the present invention includes a light emitting unit and the polarizer, a half width of wavelength band of light from the light emitting unit is not greater than 20 nm, and the polarizer is arranged so as to reflect not less than 50% of the light from the light emitting unit.

A light source apparatus as another aspect of the present invention includes a first light emitting unit configured to emit light having a central wavelength λ0 and a half width Δλ0, a second light emitting unit configured to emit light having a central wavelength λ1 and a half width Δλ1, and the polarizer, and satisfies the predetermined expressions.

An image pickup apparatus as another aspect of the present invention includes an image pickup element, an optical finder configured to optically display an observable object image not through the image pickup element, an electronic viewfinder including a light source and an image display element and configured to display an observable image obtained through the image pickup element, an ocular unit shared by the optical finder and the electronic viewfinder, and an optical path synthesizing unit configured to synthesize light from the optical finder and light from the electronic viewfinder and to emit synthesized light to the ocular unit, and the optical path synthesizing unit includes the polarizer configured to transmit the light from the optical finder and to reflect the light from the electronic viewfinder into a direction in which the light from the optical finder is transmitted.

Further features and aspects of the present invention will become apparent from the following description of exemplary embodiments with reference to the attached drawings.

### BRIEF DESCRIPTION OF THE DRAWINGS

FIG. 1 is a schematic configuration diagram of a polarizer according to an embodiment of the present invention.

FIGS. 2A and 2B illustrate spectral reflectance and transmittance of the polarizer according to the present embodiment (Embodiment 1).

FIG. 3 illustrates a reflectance of TE polarized light of the polarizer according to the present embodiment.

FIG. 4 illustrates change in a transmittance of TE polarized light of the polarizer according to the present embodiment.

FIG. 5 illustrates a relation between a grating height of a dielectric grating and a peak reflectance of the TE polarized light of the polarizer according to the present embodiment.

FIG. 6 is a schematic configuration diagram of another polarizer according to the present embodiment.

FIGS. 7A and 7B illustrate the reflectance of the TE polarized light and a reflectance TM polarized light when a grating width of the polarizer according to the present embodiment is varied.

FIGS. 8A and 8B illustrate dependencies of losses of the TE polarized light and the TM polarized light on a grating height of a metallic grating of the polarizer according to the present embodiment.

FIGS. 9A and 9B illustrate spectral reflectance and transmittance of a polarizer according to Embodiment 1.

FIGS. 10A and 10B illustrate the spectral reflectance and transmittance of the polarizer according to Embodiment 1.

FIGS. 11A and 11B illustrate spectral reflectance and transmittance of a polarizer according to Embodiment 2.

FIGS. 12A and 12B illustrate spectral reflectance and transmittance of a polarizer according to Embodiment 3.

FIG. 13 is a schematic configuration diagram of a light source apparatus according to Embodiment 4.

FIG. 14 illustrates a wavelength distribution of the light source apparatus according to Embodiment 4.

FIG. 15 is a schematic configuration diagram of an image pickup apparatus (viewfinder) according to Embodiment 5.

FIGS. 16A and 16B illustrate spectral reflectance and transmittance of a polarizer according to Embodiment 5.

FIGS. 17A and 17B illustrate the spectral reflectance and transmittance of the polarizer according to Embodiment 5.

FIGS. 18A and 18B illustrate the spectral reflectance and transmittance of the polarizer according to Embodiment 5.

FIG. 19 illustrates a cumulative transmittance of the polarizer according to Embodiment 5.

### DESCRIPTION OF THE EMBODIMENTS

Exemplary embodiments of the present invention will be described below with reference to the accompanied drawings.

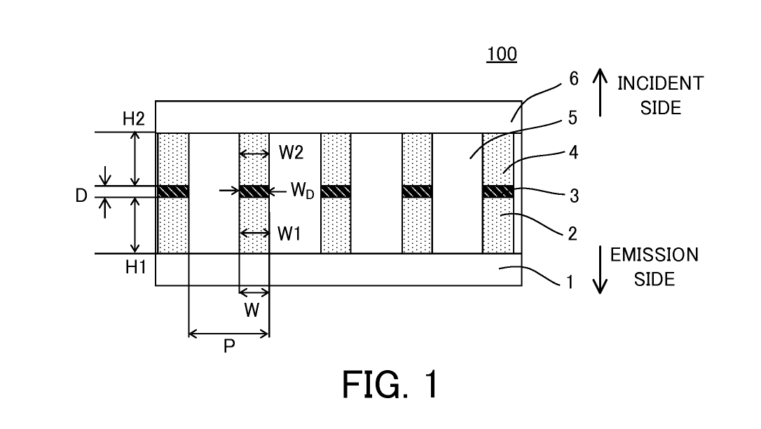

FIG. 1 is a schematic configuration diagram of a polarizer 100 according to an embodiment of the present invention. The polarizer 100 includes a plurality of laminated structures each of which includes a dielectric layer 2 (first dielectric layer), a metallic layer 3, and a dielectric layer 4 (second dielectric layer) that are laminated in this order on a medium 1 (first medium disposed at an emission side) as a substrate (between the medium 1 and a medium 6). This laminated structure is arranged periodically (in a predetermined grating period), and space between each laminated structure is filled with a medium 5 (interstitial medium). The polarizer 10 has a one-dimensional grating in which the laminated structures are arranged in one dimension (not in a meshed or matrix pattern). In the present embodiment, the plurality of metallic layers 3 in the laminated structure constitute a metallic grating or a metallic grating layer, the plurality of first dielectric layers (dielectric layers 2) in the laminated structures constitute a first dielectric grating or a first dielectric grating layer, and the plurality of second dielectric layers (dielectric layers 4) in the laminated structures constitute a second dielectric grating or a second dielectric grating layer. A top surface of the plurality of second dielectric layers 4 (second dielectric grating or second dielectric grating layer) is covered with the medium 6 (a light receiving medium or a second medium disposed at an incident side). In the present embodiment, the grating period is desirably smaller than a visible light wavelength.

In FIG. 1, symbol P represents the grating period of the laminated structure, symbol H1 represents a grating height of the dielectric grating 2, and symbol W1 represents a grating width of the dielectric grating 2. Symbol D represents a grating height of the metallic grating 3, and symbol WD represents a grating width of the metallic grating 3. Symbol H2 represents a grating height of the dielectric grating 4, and W2 represents a grating width of the dielectric grating 4. In FIG. 1, the grating width W1 of the dielectric grating 2, the grating width WD of the metallic grating 3, and the grating width W2 of the dielectric grating 4 are equal to each other and collectively represented by a grating width W.

The polarizer 100 according to the present embodiment reflects certain linearly polarized light and transmits linearly polarized light having polarization orthogonal to that of the certain linearly polarized light in a specific wavelength band (narrow wavelength band) in a visible light wavelength band (wavelength range of 400 to 700 nm). Specifically, the polarizer 100 is a narrow band polarizer configured to reflect polarized light (linearly polarized light whose polarization direction is orthogonal to a direction of the grating period also referred to as the grating period direction) oscillating in a direction orthogonal to the grating period direction, and transmitting light other than the polarized light. The thus configured polarizer 100 of the present embodiment satisfies Expressions (1) and (2) below.

0.85<ne*P*cos θ/λ<1.15 (1)

nH1−na>0.5

or

nH2−nb>0.5 (2)

In the Expressions, symbol λ represents a maximum reflectance wavelength (wavelength at which the reflectance of polarized light is maximum and the transmittance of the polarized light is minimum), and symbol θ represents an incident angle of light incident on the polarizer 100. Symbol na represents a refractive index of the medium 1 (first medium) provided on a surface of the polarizer 100 on which the dielectric grating 2 is formed, and symbol nb represents a refractive index of the medium 6 (second medium) provided on a surface of the polarizer 100 on which the dielectric grating 4 is formed. The media 1 and 6 are each a substrate that supports the dielectric gratings, and each have such a thickness that its interference effect is negligible. Symbol nH1 represents a refractive index of the dielectric grating 2, and symbol nH2 represents a refractive index of the dielectric grating 4. Symbol ne represents an effective refractive index (in the direction orthogonal to the grating period direction of the dielectric grating 2 or the dielectric grating 4) for polarized light oscillating in the direction orthogonal to the grating period direction when the dielectric grating is approximated to be an anisotropic thin film layer. An effective refractive index Ne is approximately represented by Expression (3) below when a refractive index of the interstitial medium is represented by nf.

Ne_{—}i=[nHi²*Wi²/P²+nf²*(1−Wi)²/P²]^{0.5} (i=1,2) (3)

An index i (=1, 2) denotes the dielectric grating 2 (first dielectric grating) or the dielectric grating 4 (second dielectric grating). However in reality, the gratings are shaped to have a grating period nearly equal to a wavelength, and the value of the effective refractive index Ne is somewhat different from that of Expression (3), and thus a detailed calculation needs to be performed by, for example, a rigorous couple-wave analysis. Although the effective refractive index ne may be calculated by an electromagnetic field analysis, a value calculated through Expression (3) is used as an approximate value in the present embodiment.

Through Expressions (1) and (2), the grating period P of the dielectric gratings 2 and 4 and the metallic grating 3 are set to be in an appropriate range centering on a design wavelength (wavelength λ), and the refractive indices nH1 and nH2 of the dielectric gratings 2 and 4 are set to be sufficiently large as compared to the refractive indices na and nb of the media 1 and 6. This configuration enables the polarizer 100 to have a polarization characteristic only near a desired wavelength band.

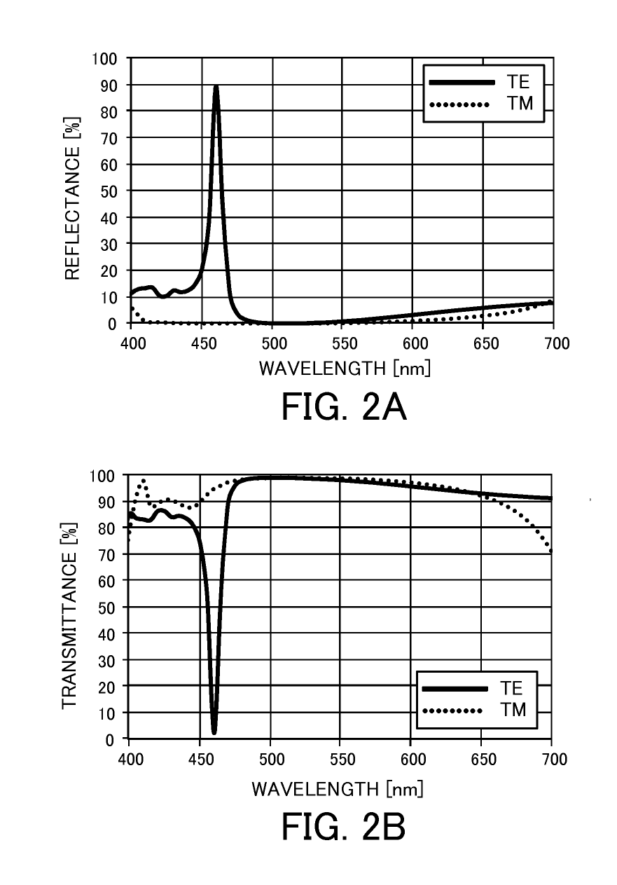

FIGS. 2A and 2B respectively illustrate a spectral reflectance and a transmittance of the polarizer 100. FIGS. 2A and 2B illustrate examples where the grating period P is 273 nm, the grating width W is 51.9 nm, the medium 1 (substrate) and the medium 6 (light receiving medium) are quartz, the dielectric gratings 2 and 4 are TiO2, the medium 5 (interstitial medium) is SiO₂, and the metallic grating 3 is Ag. In FIGS. 2A and 2B, a horizontal axis represents a wavelength, and a vertical axis represents the reflectance and the transmittance. Dotted lines and solid lines in FIGS. 2A and 2B respectively represent spectral characteristics of polarized light (TM polarized light) oscillating in a direction parallel to the grating period P and polarized light (TE polarized light) oscillating in a direction orthogonal to that of the TM polarized light. As illustrated in FIGS. 2A and 2B, the polarizer 100 according to the present embodiment is configured to have a maximum reflectance at which 90% of the TE polarization light having a wavelength of 460 nm is reflected and to transmit not less than 80% of the TE polarization light in a wavelength band not near the wavelength of 460 nm. The transmittance of the TM polarization light is not less than 90% at all wavelengths in a visible light band. As a result, the polarizer 100 is configured to polarize light having a central wavelength of 460 nm and a half width of not greater than 20 nm. Hereinafter, requirements on the polarizer 100 to have such a narrow band polarization characteristic will be described.

To avoid variation in transmittance and reflectance characteristics and an absorption loss at a short wavelength, a conventional wire grid polarizer typically has a grating period that is sufficiently small as compared to a use wavelength λ, and is not greater than a half of the use wavelength λ. In contrast, the present embodiment has a grating period close to the use wavelength so as to function as a polarizer that operates in a predetermined narrow wavelength band. When λ represents a central wavelength of the predetermined wavelength band, the wavelength λ and the grating period P are set to satisfy Expression (1), thereby achieving a polarizer having a high reflectance for a specific polarization near a desired wavelength band.

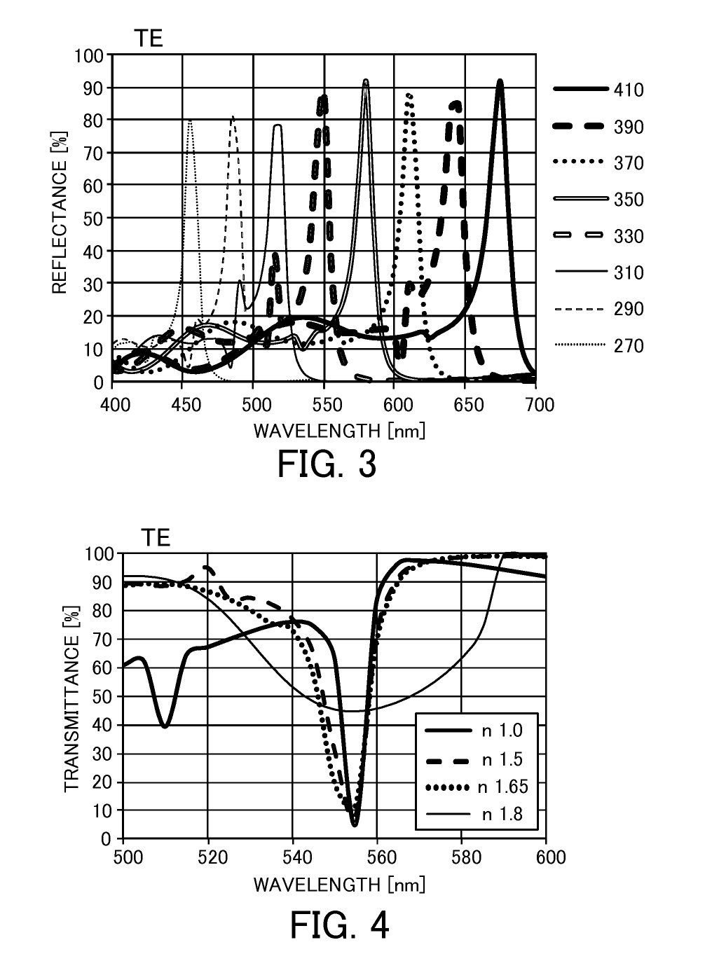

Next, a reflectance of the TE polarization light when the grating period P is changed will be described with reference to FIG. 3. FIG. 3 illustrates the reflectance of the TE polarization light of the polarizer 100. Different lines in FIG. 3 correspond to different grating periods P that are spaced at 20 nm intervals from 275 to 410 nm, whereas other parameters are parameters of Embodiment 1B in Table 1. FIG. 3 illustrates that a peak wavelength shifts to a long wavelength side as the grating period P increases. For each pair of the grating period P and the peak wavelength (wavelength λ), the value of ne*P/λ, (where cos θ=1) in Expression (1) is calculated to be 0.95 to 1.05 approximately. Thus, desired incident angle θ and wavelength λ are obtained by controlling the refractive indices and the grating width W of the dielectric gratings 2 and 4 and the interstitial medium that determine the grating period P and the effective refractive index ne, thereby achieving the polarizer 100 that performs polarization separation only near an optional wavelength. However, since the value of ne*P cos θ/λ, is not necessarily an optimum value near 1.0 and changes due to, for example, a shift from the approximate value, it is practically preferable to set the value of Expression (1) to be in a range of 0.85 to 1.15. The value of Expression (1) of not greater than 0.85 indicates difficulties in achieving a polarizer having the narrow band polarization characteristic in the visible light wavelength band. On the other hand, the value of Expression (1) of not less than 1.15 is not preferable because it results in an increased transmission loss due to unnecessary diffracted light. Thus, the value of ne*P cos θ/λ for the polarizer 100 according to the present embodiment is preferably set to be in the range of 0.85 to 1.15 as in Expression (1).

The polarizer 100 more preferably satisfies Expression (1a) below.

0.95<ne*P*cos θ/λ<1.05 (1a)

To achieve the narrow band polarization characteristic as illustrated in FIGS. 2A and 2B, while the grating period P satisfies the range of Expression (1), such a configuration is required that a sufficiently high reflectance is obtained at an interface between the dielectric gratings 2 and 4 and the light receiving medium (medium 6) or an light emitting medium (the medium 1). This requirement needs to be also satisfied by a color filter (Fabry-Perot filter) utilizing Fabry-Perot interference. The Fabry-Perot filter includes reflective films (a dichroic films and a metallic reflective film) formed on both surfaces of an interference layer so as to transmit only light having a wavelength near a wavelength that corresponds to an optical thickness nd of the interference layer (wavelength whose half is an integral multiple of nd) and to reflect light having other wavelengths. Since a half width as a transmission characteristic of the filter largely depends not only on the thickness of the interference layer but also on the reflectance of the dichroic film or the metallic film, a high reflection at an interface of the interference layer leads to an enhanced wavelength selection effect through the interference layer and thus achieves a narrow transmission band.

Similarly, in the polarizer 100 according to the present embodiment, a high reflectance at the interface between the dielectric gratings 2 and 4 and the light receiving medium or the light emitting medium leads to a narrow reflection band for the TE polarization light, that is, to a narrow band characteristic of the polarizer 100. FIG. 4 illustrates change in the transmittance of the TE polarization light when the refractive indices na and nb of the media 1 and 6 are changed. Different lines in FIG. 4 correspond to different refractive indices of the media 1 and 6, whereas na=nb in this case. Other parameters are parameters of Embodiment 1G in Table 1. FIG. 4 illustrates that, as the dielectric gratings 2 and 4 have higher refractive indices, that is, as an interface has a higher reflection and a refractive index difference is larger, a narrower band transmission characteristic is obtained. The polarizer 100 according to the present embodiment preferably operates in a narrow band, and a difference between the refractive index of the dielectric grating 2 or the dielectric grating 4 and the refractive index of the medium 1 or the medium 6 is preferred to be large so as to achieve an improved interface reflection.

The polarizer 100 more preferably satisfies Expression (2a) below.

nH1−na>0.65

or

nH2−nb>0.65 (2a)

Other methods include a method of improving the interface reflection by providing an interference film such as a dichroic film, or a metallic film, between the dielectric gratings 2 and 4 and the light receiving medium (medium 6) or the light emitting medium (medium 1). However, such a method increases an absorption loss through the interference film or complicates the configuration of the polarizer 100. Thus, the polarizer 100 preferably satisfies Expression (2) at both interfaces while either of the media is in contact with the dielectric gratings. To achieve the narrow band polarization characteristic, the half width is preferably set to be between 1 nm and 30 nm inclusive effectively. Thus, when λmin and λmax respectively represent minimum and maximum values of a wavelength band in which not less than 50% of light polarized in the direction orthogonal to the grating period direction is reflected, a difference of λmax−λmin (half width) is preferably between 1 nm and 30 nm inclusive. It is not preferable to have a half width longer than 30 nm because of an increased loss during an optical path synthesis. On the other hand, it is not preferable to have a half width shorter than 1 nm because of a high sensitivity that leads to unstable efficiency during the optical path synthesis.

The interface reflection is controlled by setting the height of the dielectric grating 2 or the dielectric grating 4 to be in a predetermined range centering on the wavelength λ, thereby enhancing the performance of the polarizer 100. The refractive indices of the dielectric gratings 2 and 4 are respectively denoted by nH1 and nH2, grating heights of the dielectric gratings 2 and 4 are respectively denoted by H1 and H2, and a wavelength at which the reflectance of the TE polarization light is at a maximum is denoted by λ. It is preferable to set a value of Δ=nH1*H1 or Δ=nH2*H2 to be approximately equal to the wavelength λ. However, since a shift of the value from the wavelength caused by variation in the grating heights H1 and H2 and the refractive indices would not significantly reduce the enhancement, the polarizer 100 preferably satisfies Expression (4) below.

λ−50≦Δ≦λ+50 [nm] (4)

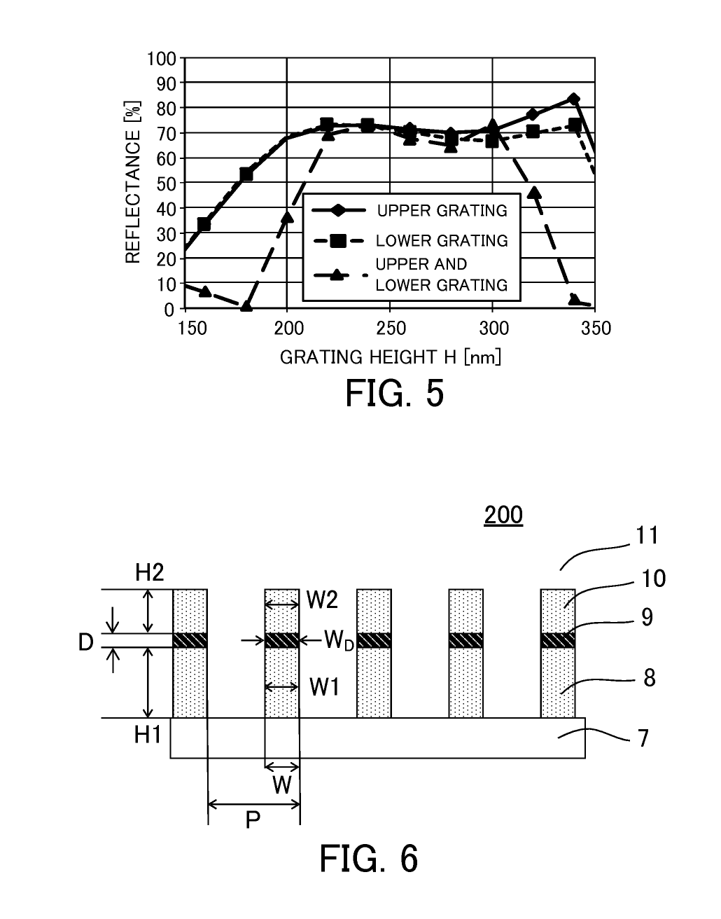

FIG. 5 illustrates a correlation between the grating heights of the dielectric gratings 2 and 4 and a peak reflectance of the TE polarization light. In FIG. 5, a horizontal axis represents the grating height, and a vertical axis represents the peak reflectance of the TE polarization light. A solid line plotted with rhombi corresponds to a case where only the grating height H2 of the dielectric grating 4 varies. A dotted line plotted with squares corresponds to a case where only the grating height H1 of the dielectric grating 2 varies. A broken line plotted with triangles corresponds to a case where the grating heights H1 and H2 vary between values on the horizontal axis. When one of the grating heights is fixed, the grating height is set to 240 nm.

FIG. 5 illustrates that, when one of the dielectric gratings 2 and 4 satisfies Expression (4) and the grating height of the other is somewhat out of the range of Expression (4), a high peak reflectance is obtained. Thus, it is preferable that at least one of the dielectric gratings 2 and 4 satisfies Expression (4). On the other hand, when the value of Δ is largely out of the range λ±50 nm of Expression (4), the reflectance in a desired band decreases. Thus, Expression (4) is preferably satisfied so as to further enhance the performance of the polarizer 100. In the present embodiment, it is more preferable to satisfy Expression (4a) below rather than Expression (4).

λ−20≦Δ≦λ+20 [nm] (4a)

FIG. 6 is a schematic configuration diagram of a polarizer 200 according to the present embodiment. The polarizer 200 differs from the polarizer 100 in that a grating height H1 of a dielectric grating 8 (first dielectric grating) and a grating height H2 of a dielectric grating 10 (second dielectric grating) are different from each other and in that a medium 11 (a light receiving medium or an interstitial medium) is air. Other components including a metallic grating 9 are the same as those of the polarizer 100 illustrated in FIG. 1. As illustrated in FIG. 6, the grating heights H1 and H2 of the first dielectric grating and the second dielectric grating may be different from each other. The interstitial medium (medium 5) and either of the medium 6 and the medium 1 may be air. However, the polarizer 200 preferably has a symmetric structure with respect to a metallic layer 3 as illustrated in FIG. 1 to reflect an interference effect on a specific wavelength.

Materials of the dielectric gratings 2 and 4 are preferably transparent in the visible light band and have high refractive indices of not less than 1.60 as understood from Expression (2). In addition, they preferably have, as substrates, refractive indices of not less than 2.0. Such materials include, for example, metallic oxide materials such as TiO2, Ta2O5, Nb2O3, ZrO2, and Al2O3, and composites thereof. The materials of the dielectric gratings 2 and 4 may be different from each other, but are preferably the same material to facilitate designing and fabrication.

The ratio W/P between the grating width W of the dielectric gratings 2 and 4 and the grating period P is preferably between 0.1 and 0.3 inclusive. Thus, when W represents the grating width of at least one of the metallic grating 3, the dielectric grating 2, and the dielectric grating 4 in the grating period direction, Expression (5) below is preferably satisfied.

0.1≦W/P≦0.3 (5)

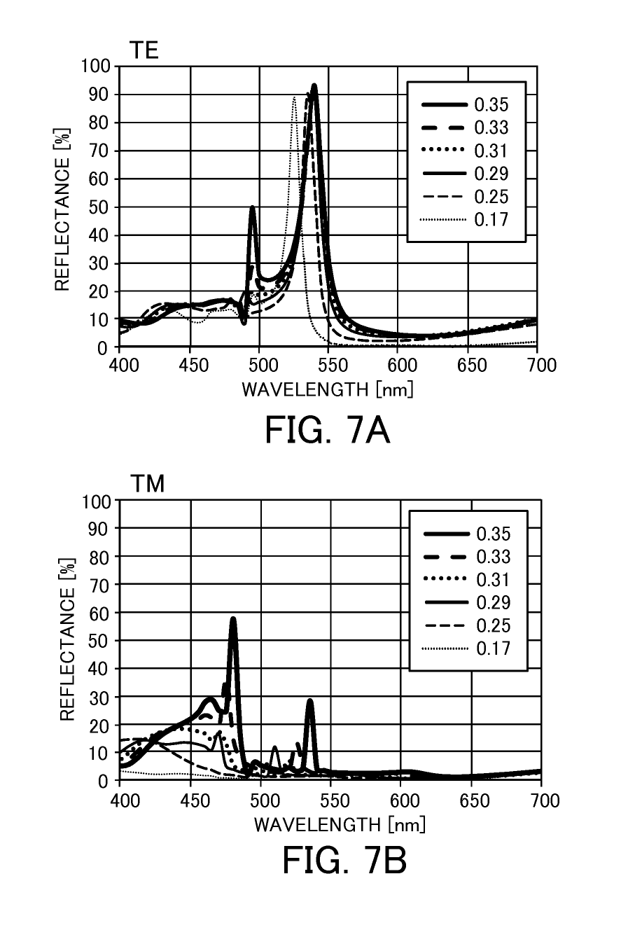

FIGS. 7A and 7B respectively illustrate the reflectance of the TE polarization light and the reflectance of the TM polarization light when the grating width W of the polarizer 100 according to the present embodiment is varied (while the grating period P is fixed). Different lines in FIGS. 7A and 7B correspond to different parameters (values of the ratio W/P) of Embodiment 1G in Table 1. When the ratio W/P is greater than 0.3, a spectrum of the TM polarization light has a peak. This potentially degrades the performance, and thus the ratio W/P is preferably set to be not greater than 0.3. On the other hand, when the ratio W/P is not greater than 0.1, an aspect ratio of a grating to the grating width W increases, which makes it difficult to fabricate and maintain a grating shape. For these reasons, the ratio W/P is preferably set to be between 0.1 and 0.3 inclusive. Although not illustrated, the grating width W1 of the dielectric grating 2, the grating width WD of the metallic grating 3, and the grating width W2 of the dielectric grating 4 may be different one another. However, ratios (W1/P, WD/P, and W2/P) of the respective grating widths are preferably between 0.1 and 0.3 inclusive. It is more preferable to satisfy Expression (5a) below rather than Expression (5).

0.15≦W/P≦0.25 (5a)

In order to facilitate manufacturing, the grating width W is more preferably fixed in the whole grating structure. Specifically, the grating widths of the dielectric grating 2 and the dielectric grating 4 (and the metallic grating 3) in the grating period direction are preferably the same.

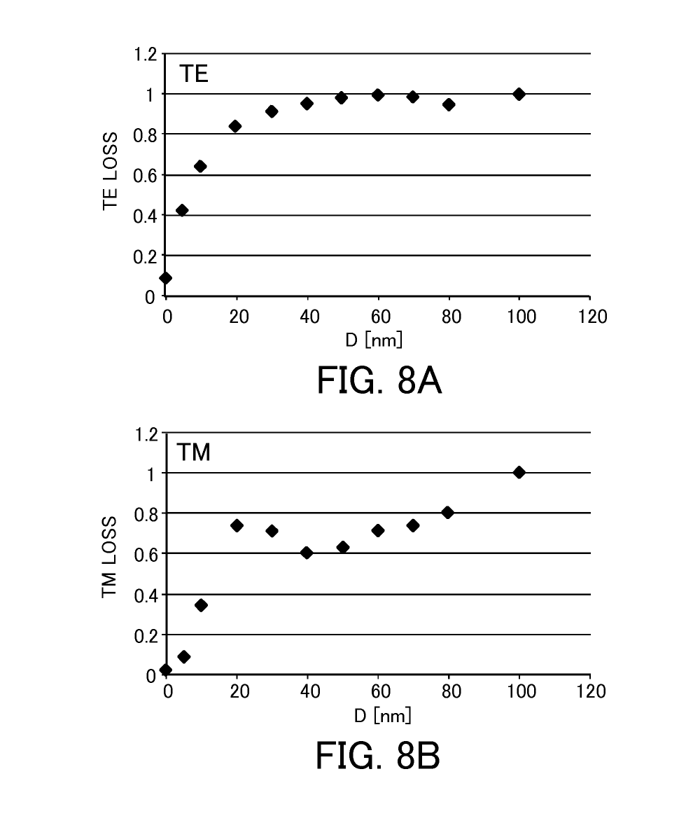

Too thick grating height D of the metallic grating 3 formed between the dielectric gratings 2 and 4 causes a loss due to light absorption. FIGS. 8A and 8B illustrate dependencies of the transmission losses of the TE polarization light and the TM polarization light on the grating height D in a range from 400 to 500 nm approximately. In FIGS. 8A and 8B, a horizontal axis represents the grating height D, and a vertical axis represents the loss. Parameters other than the grating height D are parameters of Embodiment 1B in Table 1. When the grating height D of the TE polarization light is set to be not greater than 50 nm, the loss can be reduced. When the grating height D of the TM polarization light is set to be not greater than 25 nm, the loss can be reduced. However, when the grating height D is not greater than 5 nm, the loss is reduced but the polarizer 100 cannot have stable optical performance. Thus, the grating height D (thickness) of the metallic grating 3 is preferably set to be between 5 nm and 50 nm inclusive. The grating height D is more preferably set to be between 5 nm and 25 nm inclusive.

A material of the metallic grating 3 is preferably Ag, Al, Au, Pt, or Cu that has a large extinction coefficient and a small refractive index. The use of Ag, in particular, can reduce the transmission losses in the visible light band and provide a stable polarization characteristic.

Methods of fabricating such a fine element structure as illustrated in FIG. 1 and FIG. 6 include, for example, a method described below. First, a layer of the dielectric grating 2, a layer of the metallic grating 3, and a layer of the dielectric grating 4 are formed on the substrate (medium 1) by evaporation coating or sputtering. Then, a metallic mask layer and a photoresist are applied thereon. The photoresist is exposed by a method such as interference exposure and developed to be patterned as a predetermined grating, followed by etching to form a metallic mask layer (metallic grating layer) shaped in the grating. After that, by using the metallic grating layer as a mask, etching is performed on the layer of the second dielectric grating, the metallic grating layer, and the layer of the first dielectric grating in this order so as to form a laminated structure of a three-layered grating. Preparing a sufficient thickness of the metallic mask layer can facilitate the fabrication by allowing the three-layered grating to be etched with the same mask. The interstitial medium is injected by methods such as evaporation coating and resin embedding. Alternatively, a bonding portion to bond a light receiving substrate (medium) may be used as the interstitial medium. In another method, after the interstitial medium is formed as a grating by a nanoimprint method and the dielectric gratings and the metallic grating are formed by a method such as evaporation coating, a liftoff is performed to form the laminated structure of the three-layered grating. However, the present embodiment is not limited these methods, and other methods applicable to fabrication of a fine periodic structure may be applicable.

### Embodiment 1

Next, a polarizer according to Embodiment 1 of the present invention will be described. The polarizer according to the present embodiment has a similar configuration to that of the polarizer 100 illustrated in FIG. 1, and thus a detailed description thereof is omitted. The polarizer 100 according to the present embodiment has, on the medium 1 (substrate) having a refractive index nd of 1.48, a laminated structure including a first TiO₂ (the dielectric grating 2), an Ag grating (the metallic grating 3), and a second TiO₂ grating (the dielectric grating 4). Spaces between the gratings are filled with the interstitial medium 5 having the refractive index nd of 1.48, onto which the same material as that of the substrate is bonded as the medium 6. The medium 6 and the interstitial medium 5 may be formed of the same material.

Table 1 lists parameters of the polarizer 100 according to the present embodiment and values of Expressions (1), (2), and (4). The polarizer 100 with different grating periods P serves as a B polarizer (Embodiment 1B), a G polarizer (Embodiment 1G), and an R polarizer (Embodiment 1R) that have maximum reflectance of the TE polarization light at different wavelengths. Those elements respectively satisfy Expressions (1), (2), and (4). For example, the polarizer of Embodiment 1B in Table 1 serves as a polarizer having a maximum reflectance at a wavelength of 460 nm. The value of Expression (1) is 0.997, so that the range of Expression (1) is satisfied. The value of nH1−nb (equivalent to nH2−na) is 1.0, so that Expression (2) is satisfied. The heights of the dielectric gratings 2 and 4 are 180 nm, and thus the value of nH1*H1 is 446 nm, so that Expression (4) is satisfied. Since the same is true for nH2*H2, a description thereof is omitted. Similarly, Expressions (1), (2), and (4) are satisfied for Embodiments 1G and 1R.

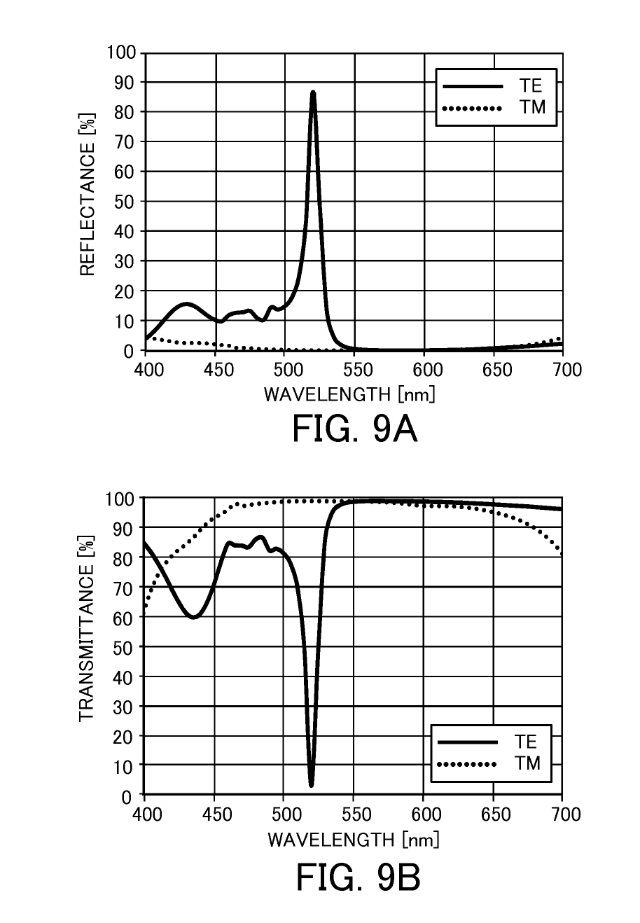

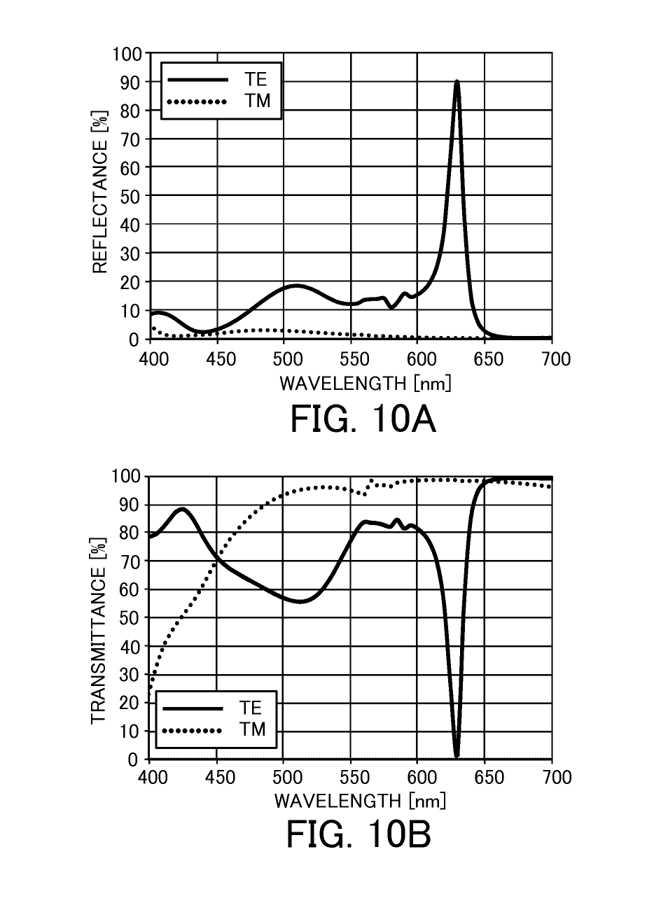

FIGS. 2A and 2B respectively illustrate spectral reflectance and transmittance of the B polarizer according to the present embodiment. FIGS. 9A and 9B respectively illustrate spectral reflectance and transmittance of the G polarizer according to the present embodiment. FIGS. 10A and 10B respectively illustrate spectral reflectance and transmittance of the R polarizer according to the present embodiment. In each of FIGS. 10A and 10B, a vertical axis, a horizontal axis, and different lines represent the same as those in FIGS. 2A and 2B, and thus a description thereof is omitted. An incident angle to the polarizer 100 is 7 degrees. The polarizer 100 according to the present embodiment has wavelengths of 460 nm, 525 nm, and 630 nm as maximum reflectance wavelengths (design wavelengths λ), and reflects only the TE polarization light in a band whose half width (λmax−λmin) is not greater than 20 nm and transmits light other than the TE polarization light in the band.

### Embodiment 2

Next, a polarizer according to Embodiment 2 of the present invention will be described. The polarizer according to the present embodiment has the same schematic structure as that of Embodiment 1, and thus a detailed description thereof is omitted. However, although the polarizer according to Embodiment 1 operates with an incident angle of 0 degree, the polarizer according to the present embodiment is configured to operate with an incident angle of 45 degrees (converted to 28.5 degrees in the light receiving medium).

Table 2 lists parameters of the polarizer according to the present embodiment and values of Expressions (1), (2), and (4). The polarizer according to the present embodiment is configured to have a maximum reflectance of the TE polarization light at a wavelength of 525 nm. With this configuration, the value of Expression (1) is 0.974, so that the range of Expression (1) is satisfied. The value of nH1−nb (equivalent to nH2−na) is 0.85, so that Expression (2) is satisfied. The grating heights H1 and H2 of the dielectric gratings 2 and 4 are 215 nm, and thus the value of nH1*H1 is 501 nm, so that Expression (4) is satisfied. The value of nH2*H2 is the same.

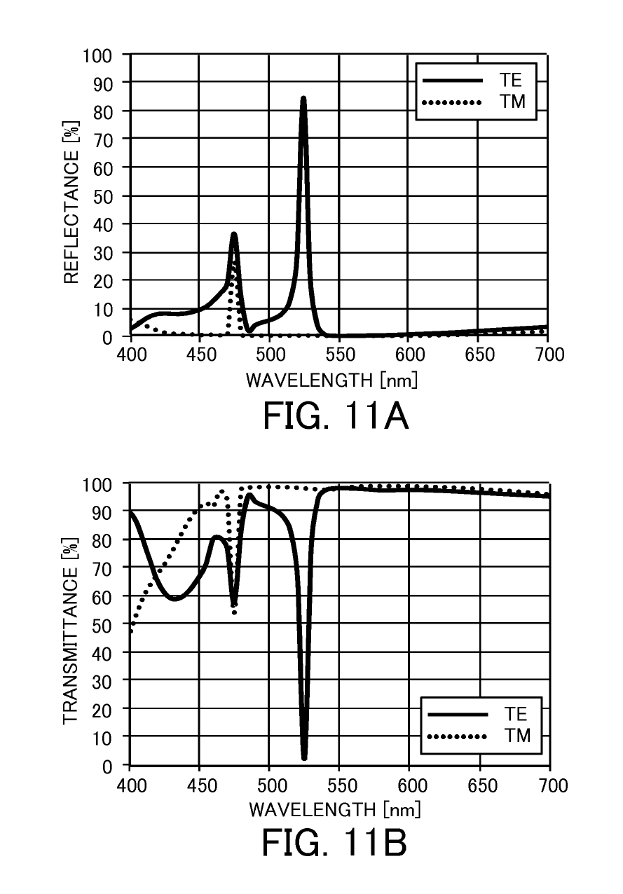

FIGS. 11A and 11B respectively illustrate spectral reflectance and transmittance of the polarizer according to the present embodiment. In each of FIGS. 11A and 11B, a vertical axis, a horizontal axis, and different lines represent the same as those in FIGS. 2A and 2B. The incident angle to the polarizer is 27.7 degrees in a medium having a refractive index of 1.48. The polarizer according to the present embodiment has a maximum reflectance at a wavelength of 525 nm and reflects only the TE polarization light in a band whose half width (λmax−λmin) is not greater than 10 nm and transmits light other than the TE polarization light in the band.

### Embodiment 3

Next, a polarizer according to Embodiment 3 of the present invention will be described. The polarizer according to the present embodiment has the same schematic structure illustrated in FIG. 6, and thus a detailed description thereof is omitted. In the polarizer according to the present embodiment, the interstitial medium and the medium 11 are air, and the grating height H1 of the dielectric grating 8 (first dielectric grating) and the grating height H2 of the dielectric grating 10 (second dielectric grating) are different from each other.

Table 3 lists parameters of the polarizer according to the present embodiment and values of Expressions (1), (2), and (4). The polarizer according to the present embodiment is configured to have a maximum reflectance of the TE polarization light at a wavelength of 460 nm. With this configuration, the value of Expression (1) is 1.108, so that the range of Expression (1) is satisfied. The value of nH1−nb is 0.96, and the value of nH2−na is 2.48, so that Expression (2) is satisfied. The grating height H1 of the first dielectric grating is 195 nm, and the grating height H2 of the second dielectric grating is 65 nm, and thus the value of nH*H1 is 484 nm, and the value of nH*H2 is 161 nm, so that at least the value of nH*H1 satisfies Expression (4).

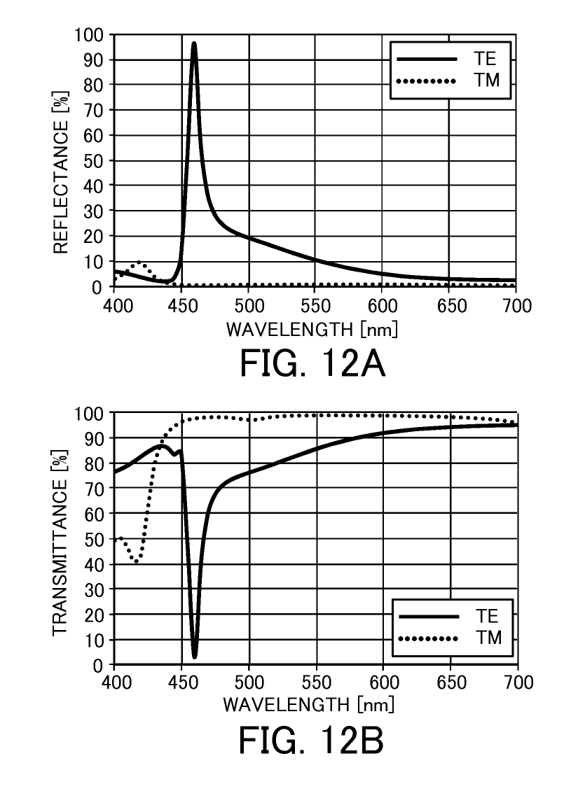

FIGS. 12A and 12B respectively illustrate spectral reflectance and transmittance of the polarizer according to the present embodiment. In each of FIGS. 12A and 12B, a vertical axis, a horizontal axis, and different lines represent the same as those in FIGS. 2A and 2B, and the incident angle to the polarizer is 0 degrees. The polarizer according to the present embodiment reflects only the TE polarization light in a band whose half width (λmax−λmin) with a peak at a wavelength of 460 nm is not greater than 10 nm, and transmits light other than the TE polarization light in the band.

### Embodiment 4

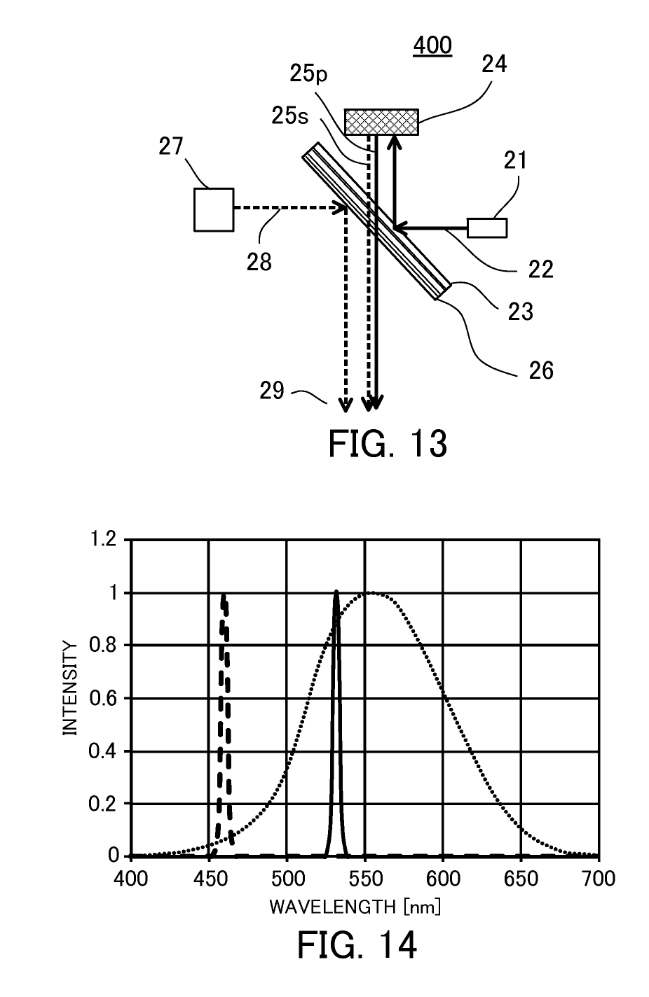

Next, an optical apparatus (light source apparatus) according to Embodiment 4 of the present invention will be described. FIG. 13 is a schematic configuration diagram of a light source apparatus 400 according to the present embodiment. The light source apparatus 400 includes a first light source 21 (first light emitting unit), a color-selective reflective layer 23, a fluorescent material 24, a polarization separation layer 26, and a second light source 27 (second light emitting unit).

First, excitation light 22 emitted from the first light source 21 is reflected by the color-selective reflective layer 23 configured to reflect light having a wavelength of the first light source 21 and to transmit light having an emission wavelength of the fluorescent material 24, and illuminates the fluorescent material 24. The fluorescent material 24 is excited by the excitation light 22 to emit fluorescence 25p and 25s having wavelengths longer than that of the excitation light 22. The indices p and s represent lights polarized orthogonally to each other. Each of the fluorescence 25p and 25s is mostly transmitted through the color-selective reflective layer 23 and the polarization separation layer 26 and is emitted to a light emitting side 29. In the light source apparatus 400, the second light source 27 having a wavelength different from that of the first light source 21 is disposed opposite to the first light source 21. The second light source 27 is a laser light source, and illumination light 28 emitted from the second light source 27 is reflected mostly by the polarization separation layer 26, is provided with an optical path synthesis with the fluorescence 25p and 25s, and is emitted to the light emitting side 29.

In the light source apparatus 400 according to the present embodiment, the polarization separation layer 26 synthesizes the fluorescence 25p and 25s having a wide band (broad) wavelength distribution with a half width Δλ0 and the illumination light 28 having a narrow band wavelength distribution with a half width Δλ1. The polarizer according to Embodiment 2 when used as the polarization separation layer 26 can provide an improved efficiency of the optical path synthesis. Thus, when used as, for example, alight source for a liquid crystal projector, the polarizer can improve the luminance of a display image.

FIG. 14 illustrates the wavelength distribution of the fluorescence 25p and 25s emitted from the fluorescent material 24, a wavelength distribution of the excitation light 22 emitted from the first light source 21, and the wavelength distribution of the illumination light 28 emitted from the second light source 27. Intensity along a vertical axis in FIG. 14 is normalized with respect to a maximum value. In FIG. 14, a dotted line represents an emission wavelength distribution of the fluorescent material 24, a broken line represents an emission wavelength distribution of the first light source 21, and a solid line represents an emission wavelength distribution of the second light source 27. The first light source 21 and the second light source 27 are laser light sources having narrow wavelength bands. The fluorescent material 24 has a peak wavelength λ0 of 550 nm and a half width Δλ0 of 100 nm approximately. The first light source 21 has a peak wavelength λ1 of 530 nm and a half width Δλ1 of 5 nm approximately. Although the wavelength distributions of these two lights have largely different bandwidths, they overlap with each other whereas one of them is natural light, so that a loss is large when a normal optical path synthesizing method is applied. Below described are Comparative Example 1 in which a dichroic film is used in place of the polarization separation layer 26 in the synthesis, and Comparative Example 2 in which a polarizing beam splitter having a wide band characteristic is used in place thereof in the synthesis.

In Comparative Example 1 in which the dichroic film is used in the optical path synthesis, the dichroic film is only capable of transmitting light on one of a long wavelength side and a short wavelength side with respect to a laser light as a reference wavelength and of reflecting light on the other. This degrades use efficiency of the light emitted from the fluorescent material. The use efficiency of the light emitted from the fluorescent material can be enhanced by improving a transmittance characteristic of the dichroic film. However, this degrades the use efficiency of the laser light.

In an optical path synthesis through the wide band polarizing beam splitter as Comparative Example 2, since the laser light is typically a linearly-polarized light, an oscillation direction of the linearly-polarized light as the laser light and a polarization separation characteristic of the polarizing beam splitter are utilized to enable efficient reflection. For example, a typical wire grid polarizer may be arranged such that a longitudinal direction of a grid and a polarization direction are parallel to each other. However, in a case of light from a fluorescent material, while light polarized in one direction, that is, the fluorescence 25p in the arrangement described above, is highly efficiently transmitted, the fluorescence 25s polarized orthogonally thereto is reflected. This degrades use efficiency of the light from the fluorescent material. In this case, lowering the polarization separation characteristic (reducing the reflectance of the fluorescence 25s while increasing the transmittance thereof) can improve the use efficiency of the light from the fluorescent material, but the use efficiency of the laser light is degraded accordingly.

On the other hand, a configuration according to the present embodiment can provide an optical path synthesis with a minimum loss. When the fluorescence 25p and 25s are transmitted through the polarization separation layer 26, only part of the fluorescence 25s having a specific wavelength band is reflected due to a transmittance characteristic illustrated in FIG. 11B. At the same time, an average of not less than 90% of light in other bands is transmitted, and an average of not less than 95% of the fluorescence 25p in all bands is transmitted. The illumination light 28 from the second light source 27 is a linearly-polarized light, and an arrangement is made such that an emission wavelength λ1 thereof and a wavelength at which a TE reflectance of the polarization separation layer 26 has a peak are substantially equal to each other. Specifically, when λmin represents a minimum wavelength of a band in which the TE polarization light is highly reflected by the polarizing beam splitter, that is, a band in which not less than 50% of the light is reflected, and λmax represents a maximum wavelength thereof, an arrangement is made such that the relation of λmin<λ1<λmax is held. Thus, not less than 90% of the illumination light is reflected. As a result, not less than 90% of the fluorescence 25p and 25s from the fluorescent material 24 and the light from the second light source 27 can be used. In this manner, the polarizer according to the present embodiment can reduce decrease in the use efficiency due to a loss during the optical path synthesis.

The use of the light source apparatus 400 according to the present embodiment as the light source of the projector enables the laser light and the light from the fluorescent material to be efficiently synthesized to display a high luminance image. In addition, a wider green light band as compared to a case of using only the laser light can reduce intensities of red and blue lights needed to display white light. This facilitates balancing of the number of lasers needed for each color and intensity thereof. Such a selection is possible that the laser light source is used when color is prioritized, and the fluorescent material or another wide band light source is used when luminance is prioritized. As a result, the color and the luminance can be selectively prioritized without reducing light use efficiency.

The light source apparatus 400 is an example of the present embodiment and is not limited to the optical path synthesis of light from a green band fluorescent material and laser light. For example, in place of the first light source 21 and the color-selective reflective layer 23, a light source such as an LED or a mercury lamp may be used as the fluorescent material 24. The polarizer according to the present embodiment can be used with the second light source 27 that emits light having a wavelength of other than 530 nm and is, for example, a blue light source of a wavelength near 460 nm or a red light source of a wavelength near 640 nm. The incident angle of the optical path synthesis may be different from 45 degrees, and various configurations of the element are possible in accordance with the angle.

The light source apparatus (optical apparatus) according to the present embodiment includes a light emitting unit (the first light emitting unit or the second light emitting unit) and the polarizer 100. Preferably, a half width of a wavelength band of light from the light emitting unit is not greater than 20 nm, and the polarizer 100 is arranged so as to reflect not less than 50% of the light from the light emitting unit.

The light source apparatus of the present embodiment includes the first light emitting unit that emits light having the central wavelength λ0 and the half width Δλ0, and the second light emitting unit that emits light having the central wavelength λ1 and the half width Δλ1. The polarizer 100 is configured to transmit not less than 50% of light from the first light emitting unit and to reflect not less than 50% of light from the second light emitting unit into a direction in which the light from the first light emitting unit is transmitted. When λmin represents a minimum value of a wavelength band in which not less than 50% of the light from the second light emitting unit is reflected, and λmax represents a maximum value thereof, Expressions (6) and (7) below are preferably satisfied.

Δλ0>Δλ1 (6)

λmin<λ1<λmax (7)

More preferably, the first light emitting unit includes a fluorescent material or a solid light emitting element, and the second light emitting unit includes a laser light source.

### Embodiment 5

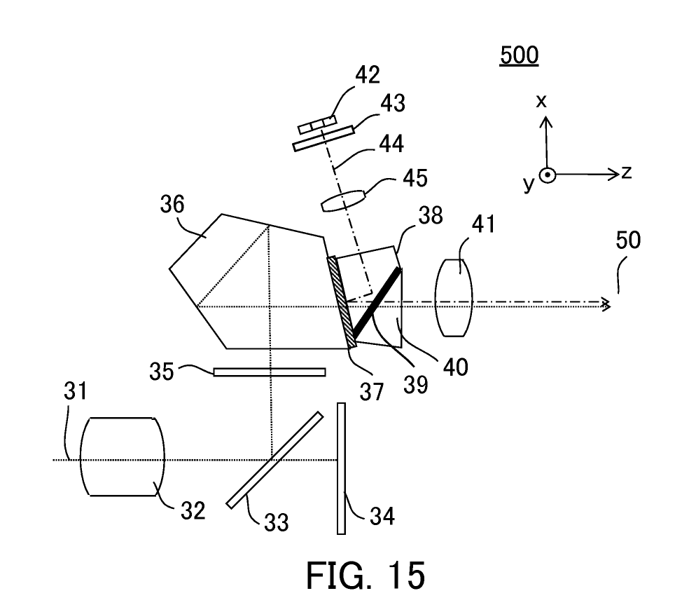

Next, an image pickup apparatus according to Embodiment 5 of the present invention will be described. FIG. 15 is a schematic configuration diagram of an image pickup apparatus 500 according to the present embodiment. The image pickup apparatus 500 is configured to superimpose an object light 31 and an image light 44 from an image display element 43 and to display a resultant image. First, the object light 31 is guided through an image pickup optical system 32 into an image pickup element 34. At the same time, the object light 31 is reflected by a semi-reflective mirror 33 (or a movable mirror) and imaged on a focusing plate 35. After that, the object light 31 is passed through a penta prism 36, a polarizer 37, a prism 38, a reflecting surface 39, and a prism 40, and guided through an ocular optical system 41 to an eye piece 50 (optical finder). In this manner, the optical finder optically displays an observable object image not through the image pickup element 34.

Meanwhile, an image signal obtained by the image pickup element 34 is sent to the image display element 43. The image display element 43 modulates light from a light source 42 in response to the image signal thus obtained and transmits modulated light as the image light 44. After transmitted through an optical system 45, the image light 44 is incident at a predetermined angle on the reflecting surface 39 provided with an air gap thereon, and is mostly reflected at the reflecting surface 39. Then, the image light 44 is reflected again by the polarizer 37 to be synthesized into the same optical path as that of the object light 31, and then is guided so as to be imaged at the eye piece 50 (an electronic viewfinder). As described above, the electronic viewfinder includes the light source 42 and the image display element 43, and displays an observable image obtained through the image pickup element 34. The ocular optical system 41 and the eye piece 50 (ocular unit) are shared by the optical finder and the electronic viewfinder.

The polarizer 37 of the present embodiment is an optical path synthesizing unit that synthesizes light from the optical finder and light from the electronic viewfinder and emits synthesized light to the ocular optical system 41 and the eye piece 50 (ocular unit). The polarizer 37 is arranged so as to transmit the light from the optical finder and to reflect the light from the electronic viewfinder into a direction in which the light from the optical finder is transmitted.

The image pickup apparatus 500 of the present embodiment illuminates the image display element 43 with the light source 42 having a narrow band light emission characteristic. The polarizer of the present embodiment corresponding to at least one band (preferably, the green band) is used as the polarizer 37 so as to transmit the object light 31 and to reflect the image light 44, thereby synthesizing two optical paths thereof. To synthesize lights in all of the red, green, and blue bands by the polarizer of the present embodiment, three of the polarizers for the respective bands may be laminated. Alternatively, the polarizer of the present embodiment may be used only for the green band, and a reflection synthesis through a dichroic film may be performed for the red or blue band. Such a configuration can minimize reduction in a light quantity of the object light 31 and a light quantity of the image light 44, thereby maintaining the both lights bright.

A typical method of synthesizing an object light that is natural light and image light (polarized when, for example, a liquid crystal element is used) that is emitted from the image display element 43 is a method of synthesizing those lights through a polarizing or non-polarizing beam splitter. However, the use of the polarizing or non-polarizing beam splitter causes a 50% loss of the object light. In a method of controlling the separation characteristic so as to increase a transmittance of the object light, the loss of the image light is adversely increased. For example, when a polarizing beam splitter that reflects 50% of the TE polarization light and transmits 100% of the TM polarization light is used, the use efficiency of the object light is 75% while the use efficiency of the image light is decreased to 50%. When a thin film polarizing beam splitter is used, the incident angle needs to be set to be substantially 45 degrees, which results in increased sizes of the prisms 38 and 40. On the other hand, when a wire grid polarizing beam splitter is used, 20 to 30% of light is lost due to absorption. The image pickup apparatus 500 of the present embodiment can achieve use efficiency of not less than 75% for the object light and the image light, and can have a compact configuration as compared to the case of using the thin film polarizing beam splitter.

Table 4 lists parameters of the polarizer 37 used in the image pickup apparatus 500 of the present embodiment and values of Expressions (1), (2), and (4). The polarizer 37 of the present embodiment serves as a polarizing beam splitter having a TE reflectance peak at a wavelength of 460 nm, 525 nm, or 630 nm. The values in Table 4 satisfy Expressions (1), (2), and (4).

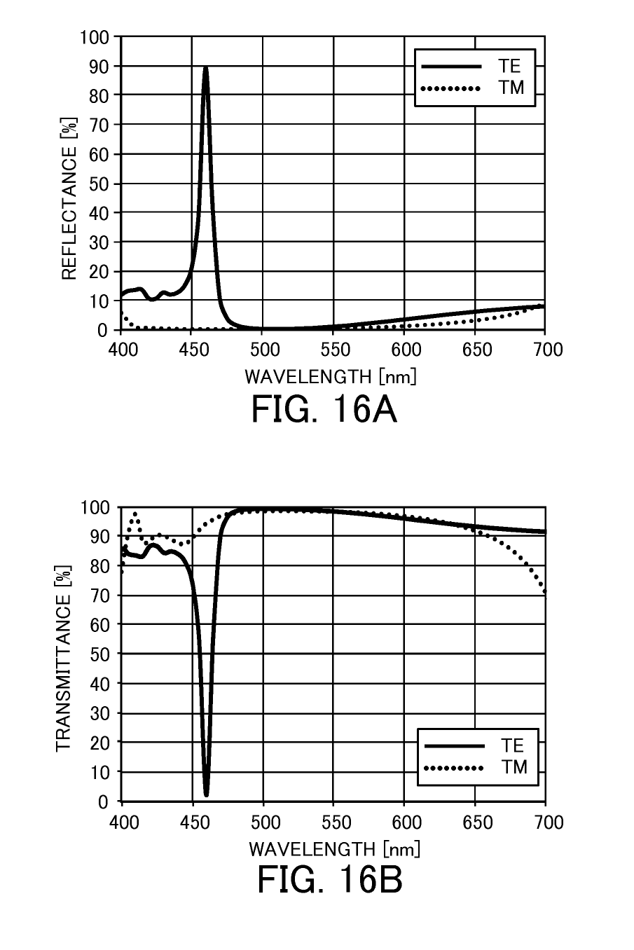

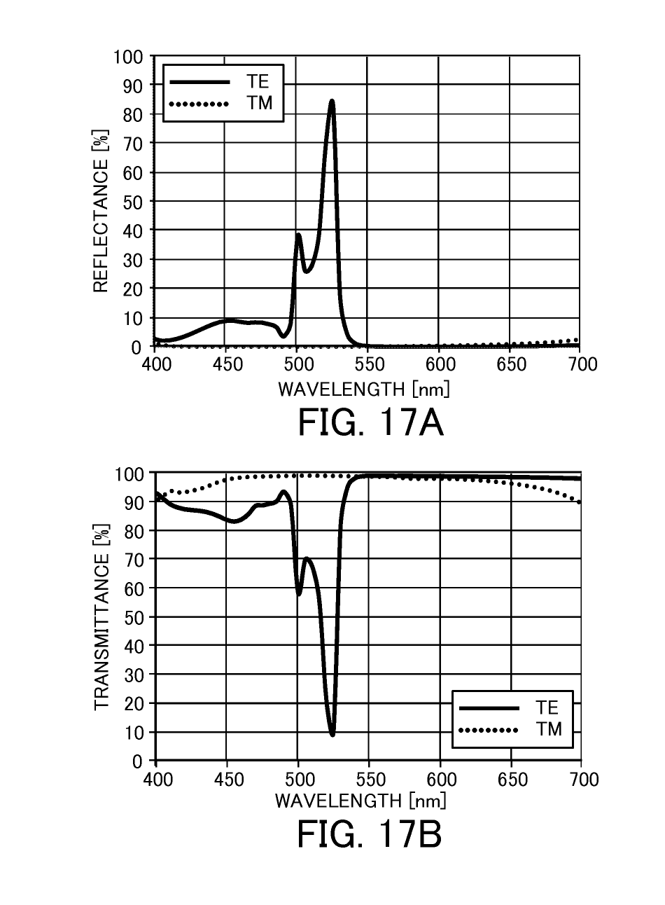

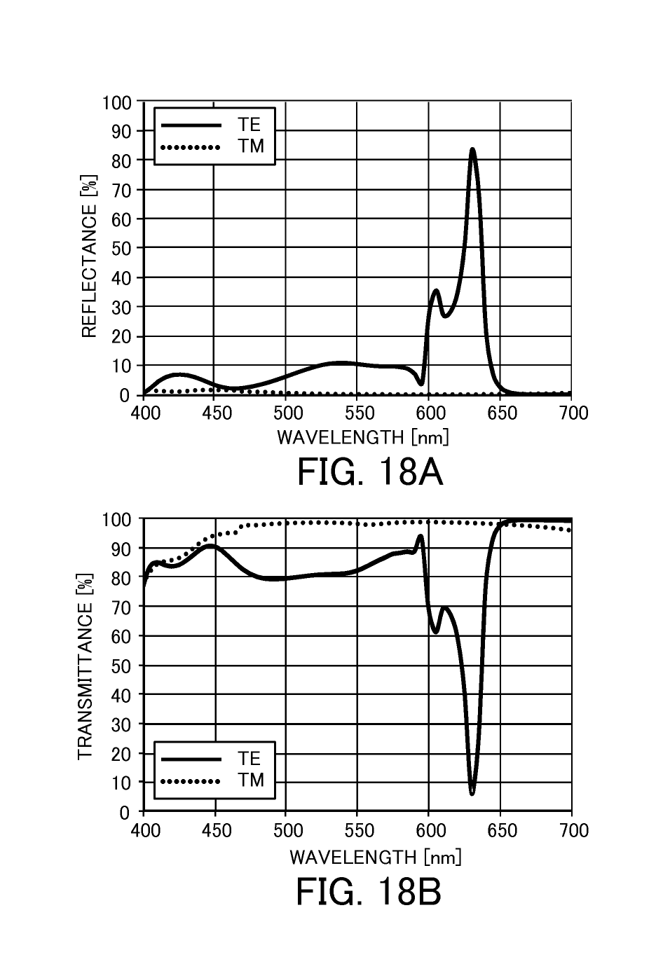

FIGS. 16A and 16B respectively illustrate spectral reflectance and transmittance of the polarizer having a TE reflectance peak at the wavelength of 460 nm. FIGS. 17A and 17B respectively illustrate spectral reflectance and transmittance of the polarizer having a TE reflectance peak at the wavelength of 525 nm. FIGS. 18A and 18B respectively illustrate spectral reflectance and transmittance of the polarizer having a TE reflectance peak at the wavelength of 630 nm. In each of these figures, a vertical axis, a horizontal axis, and different lines represent the same as those in FIGS. 2A and 2B, and the incident angle to the polarizer 37 is 7 degrees.

The polarizer 37 of the present embodiment has a slightly wider reflectance bandwidth than that of the polarizer of Embodiment 1, but accordingly has a reduced transmission loss of the TM polarization light. The polarizer 37 has a peak reflectance of not less than 80% and can achieve use efficiency of 80% of the image light collectively for a wavelength of the light source 42 and a design wavelength.

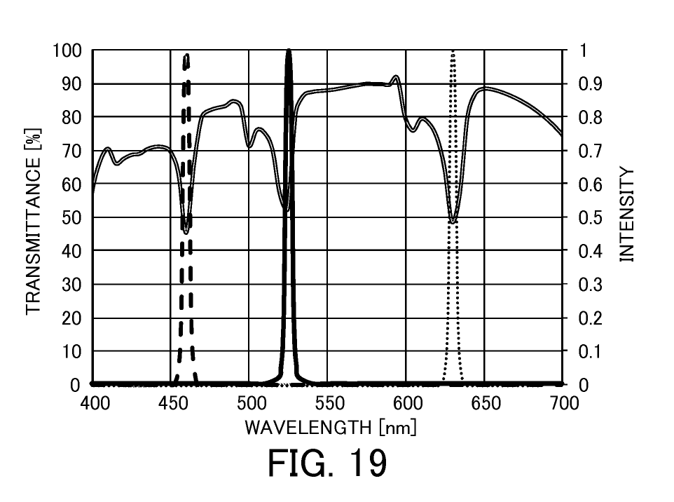

FIG. 19 illustrates a cumulative transmittance (TE/TM average value) of a lamination of all of the polarizers (three polarizers) according to the present embodiment, which is illustrated by a double line (a left axis). Spectra having wavelengths of laser light used as an illumination light of the image display element 43 are together illustrated by a broken line, a solid line, and a dotted line (a right axis). The broken line illustrates a spectrum of laser light having a central wavelength (460 nm) for blue display, the solid line illustrates a spectrum of laser light having a central wavelength (525 nm) for green display, and the dotted line illustrates a spectrum of laser light having a central wavelength (630 nm) for red display. The central wavelength of each laser light, denoted by λi, is designed to be in a range of λmax and λmin of a half width (λmin<λi<λmax) as a reflectance characteristic illustrated in FIG. 16A, 17A, or 18A. The central wavelength λi is a maximum intensity wavelength of light from the light source in either of the red, green, and blue bands. In the present embodiment, the cumulative transmittance is averaged to be 76.8% over an entire visible range, and the use efficiency of the object light is 76% approximately.

The present embodiment is configured to perform polarization separation of light in three colors from the image light through the three polarizers. Such a configuration is achieved by, for example, a method of forming polarizers of different bands on both sides of a substrate and a prism face, or by a method of laminating the polarizers with the substrate sandwiched therebetween. An alternative method may involve using a color-selective reflective film such as a dichroic film for an optical path synthesis of the red or blue band while using the polarizer according to each embodiment of the present invention only for the green band. The grating period direction of the polarizer 37 can be aligned with a direction of polarized light emitted from the light source 42 and the image display element 43, but is preferably aligned vertical to a y direction illustrated in FIG. 15 so as to reduce angle dependency.

In FIG. 15, a transmissive liquid crystal display element may be used as the image display element 43, whereas a reflective liquid crystal display element or a spatial modulation element such as DMD may be used as well. In particular, a light modulation element such as a two-dimensional scanning MEMS may be used as the image display element 43, and a laser light source may be used as the light source 42.

Each of the embodiments can provide a polarizer, an optical apparatus, a light source apparatus, and an image pickup apparatus that have a narrow wavelength band polarization characteristic.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-234504, filed on Nov. 13, 2013, which is hereby incorporated by reference herein in its entirety.

TABLE 1

| | Design | | Dielectric | | Dielectric |
|---|---|---|---|---|---|
| | wavelength | Medium | grating | Metallic | grating |
| | [nm] | na | nH1 | grating | nH2 |
| Embodiment1B | 460 | 1.48 | 2.48 | Ag | 2.48 |
| Embodiment1G | 525 | 1.47 | 2.32 | Ag | 2.32 |
| Embodiment1R | 630 | 1.46 | 2.28 | Ag | 2.28 |

| | | | Grating | | | | |
|---|---|---|---|---|---|---|---|
| | Interstitial | Medium | period P | | | | |
| | medium | nb | [nm] | W/P | H1 | D | H2 |
| Embodiment1B | 1.48 | 1.48 | 273 | 0.19 | 180 | 10 | 180 |
| Embodiment1G | 1.47 | 1.47 | 315 | 0.18 | 220 | 10 | 220 |
| Embodiment1R | 1.46 | 1.46 | 384 | 0.17 | 260 | 10 | 260 |

| | Effective | Expression | | | | |
|---|---|---|---|---|---|---|
| | refractive | (1) | (2) | (2) | (4) | (4) |
| | index ne | ne*P*cosθ/λ | nH1 − na | nH2 − nb | H1*nH1 | H2*nH2 |
| Embodiment1B | 1.693 | 0.997 | 1 | −1 | 446.4 | 446.4 |
| Embodiment1G | 1.663 | 0.990 | 0.85 | −0.85 | 510.4 | 510.4 |
| Embodiment1R | 1.643 | 0.994 | 0.82 | −0.82 | 592.8 | 592.8 |

TABLE 2

| | Design | | Dielectric | | Dielectric |
|---|---|---|---|---|---|
| | wavelength | Medium | grating | Metallic | grating |
| | [nm] | na | nH1 | grating | nH2 |
| Embodiment2 | 525 | 1.48 | 2.33 | Ag | 2.33 |

| | | | Grating | | | | |
|---|---|---|---|---|---|---|---|
| | Interstitial | Medium | period P | | | | |
| | medium | nb | [nm] | W/P | H1 | D | H2 |
| Embodiment2 | 1.48 | 1.48 | 435 | 0.17 | 215 | 10 | 215 |

| | Effective | Expression | | | | |
|---|---|---|---|---|---|---|
| | refractive | (1) | (2) | (2) | (4) | (4) |
| | index ne | ne*P*cosθ/λ | nH1 − na | nH2 − nb | H1*nH1 | H2*nH2 |
| Embodiment2 | 1.663 | 0.974 | 0.85 | 0.85 | 500.95 | 500.95 |

TABLE 3

| | Design | | Dielectric | | Dielectric |
|---|---|---|---|---|---|
| | wavelength | Medium | grating | Metallic | grating |
| | [nm] | na | nH1 | grating | nH2 |
| Embodiment2 | 460 | 1 | 2.48 | Ag | 2.48 |

| | | | Grating | | | | |
|---|---|---|---|---|---|---|---|
| | Interstitial | Medium | period P | | | | |
| | medium | nb | [nm] | W/P | H1 | D | H2 |
| Embodiment2 | 1 | 1.52 | 375 | 0.17 | 195 | 10 | 65 |

| | Effective | Expression | | | | |
|---|---|---|---|---|---|---|
| | refractive | (1) | (2) | (2) | (4) | (4) |
| | index ne | ne*P*cosθ/λ | nH1 − na | nH2 − nb | H1*nH1 | H2*nH2 |
| Embodiment2 | 1.369 | 1.108 | 1.48 | 0.96 | 483.6 | 161.2 |

TABLE 4

| | Design | | Dielectric | | Dielectric |
|---|---|---|---|---|---|
| | wavelength | Medium | grating | Metallic | grating |
| | [nm] | na | nH1 | grating | nH2 |
| Embodiment5B | 460 | 1.48 | 2.48 | Ag | 2.48 |
| Embodiment5G | 525 | 1.47 | 2.32 | Ag | 2.32 |
| Embodiment5R | 630 | 1.46 | 2.28 | Ag | 2.28 |

| | | | Grating | | | | |
|---|---|---|---|---|---|---|---|
| | Interstitial | Medium | period P | | | | |
| | medium | nb | [nm] | W/P | H1 | D | H2 |
| Embodiment5B | 1.48 | 1.48 | 273 | 0.19 | 180 | 10 | 180 |
| Embodiment5G | 1.47 | 1.47 | 315 | 0.18 | 220 | 10 | 220 |
| Embodiment5R | 1.46 | 1.46 | 384 | 0.17 | 260 | 10 | 260 |

| | Effective | Expression | | | | |
|---|---|---|---|---|---|---|
| | refractive | (1) | (2) | (2) | (4) | (4) |
| | index ne | ne*P*cosθ/λ | nH1 − na | nH2 − nb | H1*nH1 | H2*nH2 |
| Embodiment5B | 1.693 | 0.997 | 1 | −1 | 446.4 | 446.4 |
| Embodiment5G | 1.663 | 0.990 | 0.85 | −0.85 | 510.4 | 510.4 |
| Embodiment5R | 1.643 | 0.994 | 0.82 | −0.82 | 592.8 | 592.8 |

What is claimed is:

1. A polarizer comprising:
a first medium disposed at an emission side;
a second medium disposed at an incident side; and
a plurality of laminated structures provided at a predetermined grating period in a grating period direction, wherein:
the laminated structure includes, in order from the first medium to the second medium, a first dielectric layer, a metallic layer, and a second dielectric layer between the first medium and the second medium,
the polarizer is configured to reflect or absorb polarized light oscillating in a direction orthogonal to the grating period direction in a specific wavelength band and to transmit light other than the polarized light, and
the polarizer satisfies:
0.85<ne*P*cos θ/λ<1.15
and
nH1−na>0.5
or
nH2−nb>0.5,
where λ represents a wavelength at which a transmittance of the polarized light is minimum, P represents the predetermined grating period, na represents a refractive index of the first medium, and nb represents a refractive index of the second medium, and
where ne represents an effective refractive index of the first dielectric layer or the second dielectric layer in a direction orthogonal to the grating period direction and parallel to a longitudinal direction of the first dielectric layer or the second dielectric layer, nH1 represents a refractive index of the first dielectric layer, nH2 represents a refractive index of the second dielectric layer, and θ represents an incident angle of light to the second medium, and ne is given by:
ne=[nH1²*W1²/P²+nf²*(1−W1)²/P²]^{0.5}
where W1 represents a grating width of the first dielectric layer, and of represents a refractive index of a medium between each laminated structure, or
ne=[nH2²*W2²/P²+nf²*(1−W2)²/P²]^{0.5}
where W2 represents a grating width of the second dielectric layer.

2. The polarizer according to claim 1, wherein the polarizer satisfies:
0.95<ne*P*cos θ/λ<1.05.

3. The polarizer according to claim 1, wherein the grating period is not greater than a visible light wavelength.

4. The polarizer according to claim 1, wherein the polarizer satisfies:
λ−50≦Δ≦λ+50 [nm],
where H1 represents a grating height of the first dielectric layer, and H2 represents a grating height of the second dielectric layer, and
where Δ=nH1*H1 or nH2*H2.

5. The polarizer according to claim 4, wherein the polarizer satisfies:
λ−20≦Δ≦λ+20 [nm].

6. The polarizer according to claim 1, wherein a value of λmax−λmin is between 1 nm and 30 nm inclusive, where λmin represents a minimum value of a wavelength band in which not less than 50% of polarized light in the direction orthogonal to grating period direction is reflected, and λmax represents a maximum value of the wavelength band.

7. The polarizer according to claim 1, wherein the polarizer satisfies:
0.1≦W/P≦0.3
where W represents a grating width of at least one of the metallic layer, the first dielectric layer, and the second dielectric layer in the grating period direction.

8. The polarizer according to claim 7, wherein the polarizer satisfies:
0.15≦W/P≦0.25.

9. The polarizer according to claim 1, wherein grating widths of the first dielectric layer and the second dielectric layer in the grating period direction are equal to each other.

10. The polarizer according to claim 1, wherein materials of the first dielectric layer and the second dielectric layer are identical to each other.

11. The polarizer according to claim 1, wherein a grating height of the metallic layer is between 5 nm and 50 nm inclusive.

12. The polarizer according to claim 11, wherein the grating height of the metallic layer is between 5 nm and 25 nm inclusive.

13. An optical apparatus comprising:
a light emitting unit; and
a polarizer,
wherein the polarizer includes:
a first medium disposed at an emission side;
a second medium disposed at an incident side; and
a plurality of laminated structures provided at a predetermined grating period in a grating period direction, wherein:
the laminated structure includes, in order from the first medium to the second medium, a first dielectric layer, a metallic layer, and a second dielectric layer between the first medium and the second medium,
the polarizer is configured to reflect or absorb polarized light oscillating in a direction orthogonal to the lattice period direction in a specific wavelength band and to transmit light other than the polarized light, and
the polarizer satisfies:
0.85<ne*P*cos θ/λ<1.15
and
nH1−na>0.5
or
nH2−nb>0.5,
where λ represents a wavelength at which a transmittance of the polarization is minimum, P represents the predetermined grating period, na represents a refractive index of the first medium, and nb represents a refractive index of the second medium, and
where ne represents an effective refractive index of the first dielectric layer or the second dielectric layer in a direction orthogonal to the grating period direction and parallel to a longitudinal direction of the first dielectric layer or the second dielectric layer, nH1 represents a refractive index of the first dielectric layer, nH2 represents a refractive index of the second dielectric layer, and θ represents an incident angle of light to the second medium, and ne is given by:
ne=[nH1²*W1²/P²+nf²*(1−W1)²/P²]^{0.5}
where W1 represents a grating width of the first dielectric layer, and of represents a refractive index of a medium between each laminated structure, or
ne=[nH2²*W2²/P²+nf²*(1−W2)²/P²]^{0.5}
where W2 represents a grating width of the second dielectric layer, and
wherein:
a half width of a wavelength band of light of the light emitting unit is not greater than 20 nm, and
the polarizer is arranged so as to reflect not less than 50% of the light from the light emitting unit.

14. A light source apparatus comprising:
a first light emitting unit configured to emit light having a central wavelength λ0 and a half width Δλ0;
a second light emitting unit configured to emit light having a central wavelength λ1 and a half width Δλ1; and
a polarizer configured to transmit not less than 50% of the light from the first light emitting unit and to reflect not less than 50% of the light from the second light emitting unit into a direction in which the light from the first light emitting unit is transmitted,
wherein the polarizer includes:
a first medium disposed at an emission side;
a second medium disposed at an incident side; and
a plurality of laminated structures provided at a predetermined grating period in a grating period direction, wherein:
the laminated structure includes, in order from the first medium to the second medium, a first dielectric layer, a metallic layer, and a second dielectric layer between the first medium and the second medium,
the polarizer is configured to reflect or absorb polarized light oscillating in a direction orthogonal to the lattice period direction in a specific wavelength band and to transmit light other than the polarized light, and
the polarizer satisfies:
0.85<ne*P*cos θ/λ<1.15
and
nH1−na>0.5
or
nH2−nb>0.5,
where λ represents a wavelength at which a transmittance of the polarization is minimum, P represents the predetermined grating period, na represents a refractive index of the first medium, and nb represents a refractive index of the second medium, and
where ne represents an effective refractive index of the first dielectric layer or the second dielectric layer of in a direction orthogonal to the lattice period direction and parallel to a longitudinal direction of the first dielectric layer or the second dielectric layer, nH1 represents a refractive index of the first dielectric layer, nH2 represents a refractive index of the second dielectric layer, and θ represents an incident angle of light to the second medium, and ne is given by:
ne=[nH1²*W1²/P²+nf²*(1−W1)²/P²]^{0.5}
where W1 represents a grating width of the first dielectric layer, and of represents a refractive index of a medium between each laminated structure, or
ne=[nH2²*W2²/P²+nf²*(1−W2)²/P²]^{0.5}
where W2 represents a grating width of the second dielectric layer, and
wherein the polarizer satisfies:
Δλ0>Δλ1
and
λmin<λ1<λmax
where λmin represents a minimum value of a wavelength band in which not less than 50% of the light from the second light emitting unit is reflected, and λmax represents a maximum value of the wavelength band.

15. The light source apparatus according to claim 14, wherein:
the first light emitting unit includes a fluorescent material or a solid light emitting element, and
the second light emitting unit includes a laser light source.

16. An image pickup apparatus comprising:
an image pickup element;
an optical finder configured to optically display an observable object image not through the image pickup element;
an electronic viewfinder including a light source and an image display element and configured to display an observable image obtained through the image pickup element;
an ocular unit shared by the optical finder and the electronic viewfinder; and
an optical path synthesizing unit configured to synthesize light from the optical finder and light from the electronic viewfinder and to emit synthesized light to the ocular unit,
wherein the optical path synthesizing unit includes a polarizer arranged so as to transmit the light from the optical finder and to reflect the light from the electronic viewfinder into a direction in which the light from the optical finder is transmitted, and
wherein the polarizer includes:
a first medium disposed at an emission side;
a second medium disposed at an incident side; and
a plurality of laminated structures provided at a predetermined grating period in a grating period direction, wherein:
the laminated structure includes, in order from the first medium to the second medium, a first dielectric layer, a metallic layer, and a second dielectric layer between the first medium and the second medium,
the polarizer is configured to reflect or absorb polarized light oscillating in a direction orthogonal to the grating period direction in a specific wavelength band and to transmit light other than the polarized light, and
the polarizer satisfies:
0.85<ne*P*cos θ/λ<1.15
and
nH1−na>0.5
or
nH2−nb>0.5,
where λ represents a wavelength in which a transmittance of the polarization is minimum, P represents the predetermined grating period, na represents a refractive index of the first medium, and nb represents refractive index of the second medium, and
where ne represents an effective refractive index of the first dielectric layer or the second dielectric layer in a direction orthogonal to the grating period direction and parallel to a longitudinal direction of the first dielectric layer or the second dielectric layer, nH1 represents a refractive index of the first dielectric layer, nH2 represents a refractive index of the second dielectric layer, and θ represents an incident angle of light to the second medium, and ne is given by:
ne=[nH1²*W1²/P²+nf²*(1−W1)²/P²]^{0.5}
where W1 represents a grating width of the first dielectric layer, and of represents a refractive index of a medium between each laminated structure, or
ne=[nH2²*W2²/P²+nf²*(1−W2)²/P²]^{0.5}
where W2 represents a grating width of the second dielectric layer.

17. The image pickup apparatus according to claim 16, wherein the polarizer satisfies:
λmin<λi<λmax
where λi represents a wavelength at which light from the light source has a maximum intensity in at least one of red, green, blue bands, λmin represents a minimum value of a wavelength band in which not less than 50% of the light is reflected by the polarizer, and λmax represents a maximum value of the wavelength band.
